(19) United States
(12) Patent Application Publication
(10) Pub. No.: US 2024/0347805 A1
(43) Pub. Date: Oct. 17, 2024

(54) SYSTEMS AND METHODS FOR ELECTRIC VEHICLE POWERTRAIN THERMAL MANAGEMENT AND CONTROL

(71) Applicant: Nikola Corporation, Phoenix, AZ (US)

(72) Inventors: Aiden Cohan, Phoenix, AZ (US); Rachel Cook, Phoenix, AZ (US); Akshit Markan, Tempe, AZ (US); Derek McVay, Phoenix, AZ (US); Mitchell Shinn, Phoenix, AZ (US); Katherine Smith, Phoenix, AZ (US)

(21) Appl. No.: 18/757,826

(22) Filed: Jun. 28, 2024

Related U.S. Application Data
(63) Continuation of application No. 18/465,234, filed on Sep. 12, 2023.
(60) Provisional application No. 63/375,478, filed on Sep. 13, 2022.

(51) Int. Cl. H01M 10/625; H01M 10/6568; H01M 10/667; H01M 10/613

(52) U.S. Cl. CPC H01M 10/625; H01M 10/6568; H01M 10/667; H01M 10/613

(57) ABSTRACT

The present disclosure provides a powertrain thermal management system for managing thermal loads in the powertrain of an electric vehicle. The system may comprise a first coolant flow path comprising a flow split valve upstream of a first DC-DC converter, a second coolant flow path comprising a first electric motor, a third coolant flow path comprising a second electric motor, a bypass valve positioned downstream of the first DC-DC converter, the first electric motor, and the second electric motor, and a radiator positioned one of directly upstream or directly downstream of the bypass valve. The first coolant flow path, the second coolant flow path, and the third coolant flow path are fluidly connected in parallel.

### CROSS-REFERENCE TO RELATED APPLICATIONS

This application is a continuation of U.S. patent application Ser. No. 18/465,234 filed on Sep. 12, 2023, now U.S. Patent Application Publication No. 2024-0097231 entitled “SYSTEMS AND METHODS FOR ELECTRIC VEHICLE POWERTRAIN THERMAL MANAGEMENT AND CONTROL.” U.S. Ser. No. 18/465,234 claims priority to, and the benefit of, U.S. Provisional Patent Application No. 63/375,478 filed on Sep. 13, 2022, entitled “SYSTEMS AND METHODS FOR ELECTRIC VEHICLE POWERTRAIN THERMAL MANAGEMENT AND CONTROL.” The disclosure of each of the foregoing applications is incorporated herein by reference in its entirety, including but not limited to those portions that specifically appear hereinafter, but except for any subject matter disclaimers or disavowals, and except to the extent that the incorporated material is inconsistent with the express disclosure herein, in which case the language in this disclosure shall control.

### TECHNICAL FIELD

The present disclosure relates to thermal management systems, and more particularly, to thermal management control systems for electric vehicles.

### BACKGROUND

Fuel cell electric vehicles (FCEVs) utilize multiple fuel cells, combined in what is known as a fuel cell stack, to generate an electric current to power one or more system components to operate the vehicle. For example, the electric current generated by the fuel cell stack may be used to charge an onboard battery system that may be used to power one or more electric motors to drive the vehicle's wheels as well as power multiple other electrically operated systems of the vehicle. Similarly, modern battery electric vehicles (BEVs) also include a battery system capable of storing energy to be used to power the electric vehicle. For example, electric current provided to the battery system by an electrical grid may be used to power one or more electric motors to drive the vehicle's wheels as well as power other electrically operated systems of the vehicle. In electric vehicles (FCEVs and/or BEVs), various powertrain components (e.g., electric motors among others) generate substantial waste heat. Accordingly, systems and methods that efficiently cool these powertrain components in order to maximize system lifespan and performance are desirable.

### SUMMARY

A vehicle powertrain thermal management system is disclosed, comprising: a first coolant flow path comprising a flow split valve upstream of a first DC-DC converter, a second coolant flow path comprising a first electric motor, a third coolant flow path comprising a second electric motor, a bypass valve positioned downstream of the first DC-DC converter, the first electric motor, and the second electric motor, and a radiator positioned one of directly upstream or directly downstream of the bypass valve. The first coolant flow path, the second coolant flow path, and the third coolant flow path are fluidly connected in parallel.

The system may further comprise a pump upstream of the first coolant flow path, the second coolant flow path, and the third coolant flow path. The flow split valve may be a two-way valve capable of regulating a coolant flow to the first DC-DC converter. The system may further comprise a second DC-DC converter downstream of the first DC-DC converter and a third DC-DC converter downstream of the second DC-DC converter. The bypass valve may be a three-way valve configured to direct a coolant to the radiator or bypass the radiator. The first coolant flow path may further comprise an air compressor and a brake resistor controller. The brake resistor controller may be directly upstream of the flow split valve. The second coolant flow path may further comprise a first inverter directly upstream of the first electric motor. The third coolant flow path may further comprise a second inverter directly upstream of the second electric motor. The bypass valve may be directly upstream of the radiator.

A vehicle powertrain thermal management system is disclosed, comprising: a first coolant flow path comprising an air compressor and a brake resistor controller, a second coolant flow path comprising a first inverter, a third coolant flow path comprising a second inverter, a bypass valve positioned downstream of the air compressor, the brake resistor controller, the first inverter, and the second inverter, and a radiator positioned one of directly upstream or directly downstream of the bypass valve. The first coolant flow path, the second coolant flow path, and the third coolant flow path are fluidly connected in parallel.

The system may further comprise a pump directly upstream of the first coolant flow path, the second coolant flow path, and the third coolant flow path. The bypass valve may be a three-way valve configured to direct a coolant to the radiator or bypass the radiator. The bypass valve may be directly upstream of the radiator. The system may further comprise a first DC-DC converter. The first DC-DC converter may be included in the first coolant flow path. The first DC-DC converter may be downstream of the brake resistor controller. The system may further comprise a flow split valve. The flow split valve may be a two-way valve capable of regulating a coolant flow. The system may further comprise a first electric motor downstream of the first inverter and a second electric motor downstream of the second inverter.

The contents of this section are intended as a simplified introduction to the disclosure and are not intended to limit the scope of any claim. The foregoing features and elements may be combined in various combinations without exclusivity, unless expressly indicated otherwise. These features and elements as well as the operation thereof will become more apparent in light of the following description and the accompanying drawings. It should be understood, however, the following description and drawings are intended to be exemplary in nature and non-limiting.

### BRIEF DESCRIPTION OF THE DRAWINGS

The accompanying drawings are included to provide a further understanding of the present disclosure and are incorporated in, and constitute a part of, this specification, illustrate various embodiments, and together with the description, serve to explain exemplary principles of the disclosure.

FIG. 1 illustrates a perspective view of an electric vehicle containing a thermal management system, in accordance with various embodiments;

FIG. 2 illustrates a powertrain thermal management system, in accordance with various embodiments;

FIG. 3 illustrates a block diagram of control logic for implementing a method for bypass valve control and mode selection, in accordance with various embodiments;

FIG. 4 illustrates a block diagram of control logic for implementing a method for powertrain loop pump control, in accordance with various embodiments;

FIG. 5 illustrates a block diagram of control logic for implementing a method for two-way valve control, in accordance with various embodiments;

FIG. 6 illustrates a block diagram of control logic for implementing a method for coolant flow calculation, in accordance with various embodiments;

FIG. 7 illustrates a block diagram of control logic for implementing a method for powertrain heat generation calculation, in accordance with various embodiments; and

FIG. 8 illustrates a block diagram of control logic for implementing a method for radiator fan control, in accordance with various embodiments.

### DETAILED DESCRIPTION

The detailed description of various embodiments herein makes reference to the accompanying drawings, which show various embodiments by way of illustration. While these various embodiments are described in sufficient detail to enable those skilled in the art to practice the disclosure, it should be understood that other embodiments may be realized and that logical chemical, electrical, and mechanical changes may be made without departing from the spirit and scope of the disclosure. Thus, the detailed description herein is presented for purposes of illustration only and not of limitation.

For example, the steps recited in any of the method or process descriptions may be executed in any suitable order and are not necessarily limited to the order presented. Furthermore, any reference to singular includes plural embodiments, and any reference to more than one component or step may include a singular embodiment or step. Also, any reference to attached, fixed, connected, or the like may include permanent, removable, temporary, partial, full, and/or any other possible attachment option. Additionally, any reference to without contact (or similar phrases) may also include reduced contact or minimal contact.

For example, in the context of the present disclosure, methods, systems, and articles may find particular use in connection with electric vehicles, fuel cell electric vehicles, battery electric vehicles, compressed natural gas (CNG) vehicles, hythane (mix of hydrogen and natural gas) vehicles, and/or the like. However, various aspects of the disclosed embodiments may be adapted for performance in a variety of other systems. Further, in the context of the present disclosure, methods, systems, and articles may find particular use in any system requiring use of liquid-cooled powertrain components such as electric motors, electric power control components (e.g., converters and/or inverters), and/or thermal management system(s) of the same. As such, numerous applications of the present disclosure may be realized.

The following nomenclature in Table 1, Table 2, and Table 3 corresponds to measured parameters, controlled parameters, and selected parameters, respectively, described in the present disclosure:

TABLE 1
Sensor Measurements

| Measurement | |
|---|---|
| Sensor | Description |
| T_{mot, 1} | Coolant temperature at outlet of E-motor 1 (° C.) |
| T_{mot, 2} | Coolant temperature at outlet of E-motor 2 (° C.) |
| T_{DCDC} | Coolant temperature at outlet of DC-DC converter (° C.) |
| T_{p, out} | Coolant temperature at outlet of pump (° C.) |
| T_{amb} | Ambient temperature (° C.) |
| Speed_{mot, 1} | E-motor 1 speed (RPM) |
| Torque_{mot, 1} | E-motor 1 torque (N-m) |
| Speed_{mot, 2} | E-motor 2 speed (RPM) |
| Torque_{mot, 2} | E-motor 2 torque (N-m) |
| Speedᵥₑₕ | Vehicle speed (kph) |

TABLE 2
Controlled Parameters

| Controlled Parameter | Description |
|---|---|
| N_{fan} | Radiator fan speed (RPM) |
| Nₚᵤₘₚ | Powertrain loop pump speed (RPM) |
| V_{pos, 2} | Flow split (2-way) valve (%) |
| V_{pos, 3} | Bypass (3-way) valve (%) |

TABLE 3
Selected/Calculated Parameters

| Selected/Calculated | |
|---|---|
| Parameter | Description |
| T_{threshold} | Threshold coolant temperature (° C.) |
| Tₛₑₜₚₒᵢₙₜ_1 | Component outlet temperature setpoint (° C.) |
| Tₛₑₜₚₒᵢₙₜ_2 | DC-DC outlet temperature setpoint (° C.) |
| Tₛₑₜₚₒᵢₙₜ_3 | Pump outlet temperature setpoint (° C.) |
| Q_{powertrain} | Powertrain heat generation (kW) |
| V_{coolant} | Powertrain loop coolant flow (LPM) |
| Vₐᵢᵣ | Desired radiator air flow (LPM) |

Modern electric vehicles may utilize various power sources to provide electric current to one or more electric motors configured to drive the vehicle's wheels. Among the types of electric vehicles currently being researched and developed at a wide scale are FCEVs and BEVs. Similar to traditional internal combustion engine vehicles (ICEVs), electric vehicles may generate large amounts of waste heat through the operation of various system components. For example, powertrain systems such as electric motors may generate waste heat as a result of losses within the winding(s), bearing losses, core losses, and/or circulation (windage) losses. Various other powertrain components (e.g., DC-DC converters and the like) may similarly generate waste heat. This additional heat can adversely impact the operation of the powertrain component and reduce the life thereof. Accordingly, modern electric vehicles are typically equipped with one or more thermal management systems capable of managing the operating temperatures of various system components. By increasing the thermal efficiency of the thermal management system, certain components of the thermal management system may require less power from on-board batteries. As a result, battery capacity may be preserved and instead be utilized for other desirable purposes, for example to increase vehicle range.

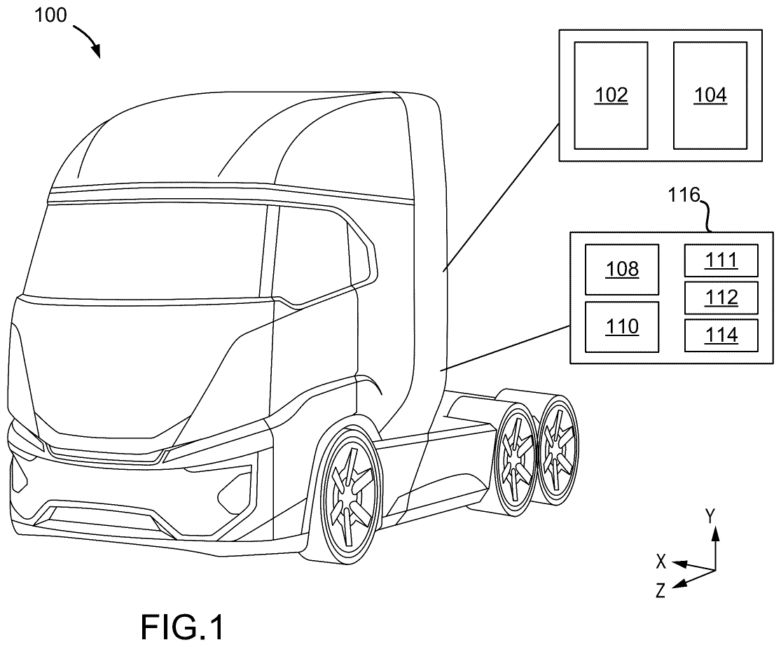

Accordingly, with reference to FIG. 1, a perspective view of a vehicle 100 incorporating a thermal management system is illustrated, in accordance with various embodiments. Vehicle 100 is an FCEV incorporating an electric powertrain. More specifically, vehicle 100 is an electric commercial vehicle, such as, for example, a class 8 heavy duty commercial vehicle. While described herein as an FCEV, vehicle 100 is not limited in this regard and may comprise any type, size, or function of vehicle. For example, vehicle 100 may comprise a BEV, CNG vehicle, hythane vehicle, or any other suitable vehicle. Moreover, vehicle 100 may comprise a commercial vehicle of a different weight class or a passenger vehicle in various embodiments. It should be appreciated that vehicle 100 may comprise any vehicle type that can utilize a thermal management system wherein waste heat from certain system components may be at least partially salvaged and/or dissipated through a liquid coolant loop as discussed in further detail below.

With continued reference to FIG. 1, vehicle 100 may comprise a fuel cell stack 102 and a battery 104. Fuel cell stack 102 and/or battery 104 may be configured to power one or more electric motors 108 to drive vehicle 100. For example, fuel cell stack 102 and/or battery 104 may operate alone, in an alternating fashion, and/or in an alternating or staggered fashion to provide current to the one or more electric motors 108 depending on operational objectives or conditions. As a result, fuel cell stack 102 and battery 104 may undergo times of relatively low energy output (corresponding to relatively low heat output) and times of relatively high energy output (corresponding to relatively high heat output). Additionally, battery 104 may undergo periods of elevated heat output responsive to charging of battery 104. While described as having both fuel cell stack 102 and battery 104, vehicle 100 is not limited in this regard and in various embodiments may comprise only battery 104, for example when vehicle 100 is a BEV.

In various embodiments, fuel cell stack 102 may comprise one or more fuel cells capable of facilitating an electrochemical reaction to produce an electric current. For example, the one or more fuel cells may be proton-exchange membrane (PEM) fuel cells which may receive a fuel source (such as diatomic hydrogen gas) which may react with an oxidizing agent (such as oxygen) to generate electricity with heat and water as byproducts. The fuel cells may be electrically coupled in series and/or parallel to increase voltage and/or current and form fuel cell stack 102. In various embodiments, fuel cell stack 102 may comprise fuel cells other than PEM fuel cells, for example, alkaline fuel cells, phosphoric acid fuel cells, molten carbonate fuel cells, solid oxide fuel cells, or any other suitable fuel cell type.

Battery 104 may be a rechargeable, or secondary, battery configured to store energy from an external power source (for example, a charging station), from fuel cell stack 102, from a solar panel disposed on vehicle 100, and/or from regenerative braking or other applications. Battery 104 may release this stored energy in the form of electricity to power one or more electric motors 108 and/or to supply power to other vehicle components utilizing electricity to operate. For example, battery 104 and/or fuel cell stack 102 may power other vehicle components such as an air compressor 110, one or more inverters 111, one or more DC-DC converters 112, a brake resistor controller 114, and so forth. In various embodiments, battery 104 may be a lithium-ion battery; however, battery 104 is not limited in this regard and may comprise other rechargeable battery types such as a lead-acid battery, nickel-cadmium battery, nickel-metal hydride battery, lithium iron sulfate battery, lithium iron phosphate battery, lithium sulfur battery, solid state battery, flow battery, or any other type of suitable battery. Battery 104 may further comprise multiple battery cells coupled in series and/or parallel to increase voltage and/or current. The cells of battery 104 may comprise any suitable structure including cylindrical cells, prismatic cells, or pouch cells. Moreover, battery 104 may at least partially comprise other energy storage technologies such as an ultracapacitor.

In various embodiments, vehicle 100 comprises a thermally managed powertrain arrangement, comprising one or more electric motors 108, air compressor 110, one or more inverters 111, one or more DC-DC converters 112, a brake resistor controller 114, and so forth, and which may be thermally regulated by a powertrain thermal management system 116. In various embodiments, powertrain thermal management system 116 includes one or more controllers (e.g., processors) and one or more tangible, non-transitory memories capable of implementing digital or programmatic logic. In various embodiments, for example, the one or more controllers are one or more of a general purpose processor, digital signal processor (DSP), application specific integrated circuit (ASIC), field programmable gate array (FPGA), or other programmable logic device, discrete gate, transistor logic, or discrete hardware components, or any various combinations thereof or the like. In various embodiments, as will be discussed in further detail below, powertrain thermal management system 116 is configured to monitor and/or manage temperatures of various powertrain components such as electric motors 108, air compressor 110, inverters 111, DC-DC converters 112, brake resistor controller 114, control electronics of the same, and/or other system components. For example, powertrain thermal management system 116, which can be in thermal communication with electric motors 108, air compressor 110, inverters 111, DC-DC converters 112, brake resistor controller 114, and other system components, may comprise one or more coolant loops configured to transfer thermal energy from areas of higher temperature to areas of lower temperature.

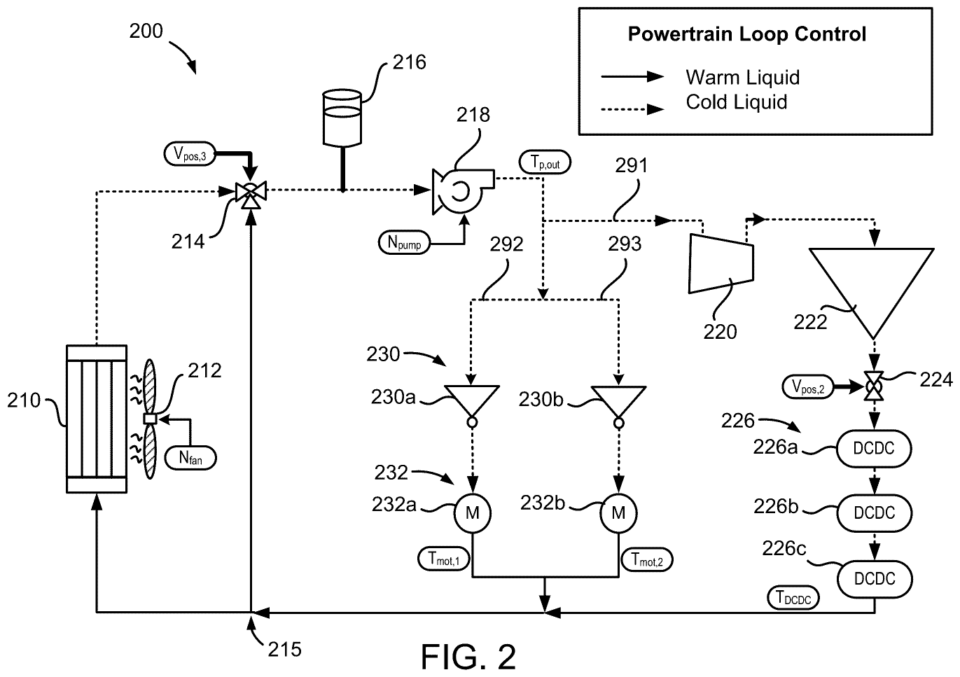

With reference now to FIG. 2, a powertrain thermal management system 200, which may be similar to powertrain thermal management system 116 of FIG. 1, is illustrated in accordance with various embodiments. In various embodiments, the powertrain thermal management system 200 operates in one of two modes: radiator mode or bypass mode. In the radiator mode, coolant flows through the radiator 210 to reject the heat generated by powertrain components (e.g., electric motors 232, inverters 230, and the like) to the surrounding environment. The bypass mode may be used in colder (e.g., freezing) ambient conditions, where the coolant bypasses the radiator 210 in order to increase its temperature using the heat generated by the powertrain components.

Powertrain thermal management system 200 comprises two types of components: thermally managed components and thermal-hydraulic components. The thermally managed components may include electric motors 232 (e.g., electric motor 232a and electric motor 232b), inverters 230 (e.g., inverter 230a and inverter 230b), air compressor 220, and other electronic components such as DC-DC converters 226 (e.g., DC-DC converter 226a, DC-DC converter 226b, and DC-DC converter 226c) and brake resistor controller 222. The thermal-hydraulic components may include a pump 218, a flow split valve 224 (also referred to as a two-way valve), a bypass valve 214 (also referred to as a three-way valve), a radiator 210 and associated fan 212, and an expansion tank 216.

In various embodiments, air compressor 220, brake resistor controller 222, flow split valve 224, and DC-DC converters 226 are fluidly connected along a first coolant flow path 291 in series. In various embodiments, inverter 230a and electric motor 232a are fluidly connected along a second fluid flow path 292 in parallel with the first coolant flow path 291 (i.e., in parallel with air compressor 220, brake resistor controller 222, flow split valve 224, and DC-DC converters 226). In various embodiments, inverter 230a and electric motor 232a are fluidly connected in series. In various embodiments, inverter 230b and electric motor 232b are fluidly connected in series along a third fluid flow path 293. In various embodiments, inverter 230a and electric motor 232a are fluidly connected in parallel with inverter 230b and electric motor 232b (i.e., the second fluid flow path 292 may be in parallel with the third fluid flow path 293).

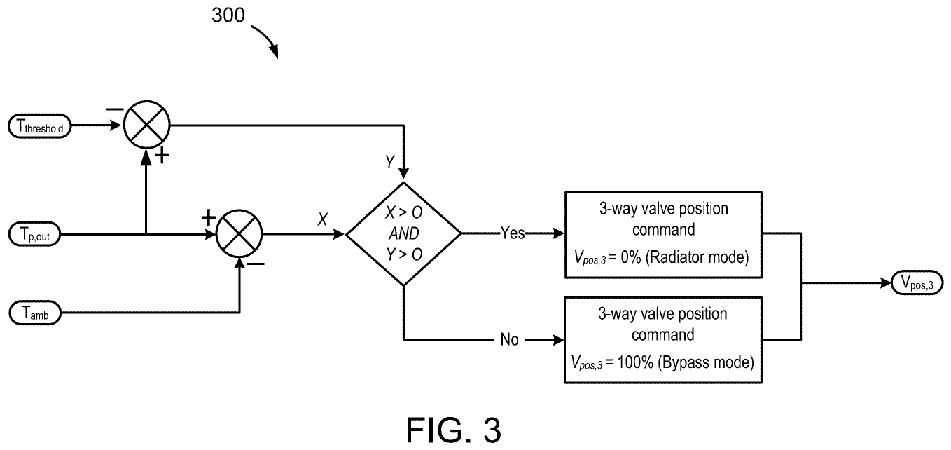

To provide desirable cooling capacity for the powertrain components, the thermal-hydraulic electronic components are regulated using feedback and/or feedforward control methodology. Powertrain thermal management system 200 may be configured to remove waste heat from electric motors 232 and/or DC-DC converters 226, among other components, to ensure electric motors 232 and/or DC-DC converters 226 operate within a desired temperature range, for example for efficiency, safety, longevity, reliability, or other desirable purposes. This method may involve a coolant temperature sensor (T_{p,out}) at the outlet of the pump 218, coolant temperature sensors (T_{mot,1} and T_{mot,2}) at the outlet of each electric motor 232a and 232b, and a coolant temperature sensor (T_{DCDC}) at the outlet of the DC-DC converter 226c. Also, the control method may utilize the ambient temperature sensor (T_{amb}), which may be located on the truck cab, and internal electric motor (speed, torque) measurements. In various embodiments, the bypass valve 214 is used to toggle the powertrain thermal management system 200 between radiator mode and bypass mode. If the pump outlet temperature (T_{p,out}) is greater than the ambient temperature (T_{amb}) and greater than a threshold coolant temperature (e.g., T_{threshold} could be 0° C. or another temperature as desired), the bypass valve 214 may transition the powertrain loop to radiator mode. If any of the above conditions are not met, the bypass valve 214 may stay in bypass mode. A block diagram for bypass valve control and mode selection is shown in FIG. 3.

With continued reference to FIG. 3, a block diagram of control logic 300 for a thermal management system (e.g., powertrain thermal management system 200) is illustrated, in accordance with various embodiments. Control logic 300 may implement a method for managing thermal loads in an electric vehicle (e.g., a BEV and/or a FCEV). More specifically, control logic 300 may be implemented for toggling the powertrain thermal management system 200 between radiator mode and bypass mode. With combined reference to FIG. 2 and FIG. 3, control logic 300 may receive a measured coolant temperature (e.g., T_{p,out}), also referred to herein as a first coolant temperature. In an exemplary embodiment, the coolant temperature is measured at an outlet of pump 218, though it should be understood that in various embodiments the coolant temperature may be measured at any suitable location downstream from radiator 210 and upstream from the thermally managed component(s). In this regard, the method may comprise measuring coolant temperature (T_{p,out}). Control logic 300 may determine whether the measured coolant temperature is greater than a threshold temperature (T_{threshold}) and greater than an ambient temperature (T_{amb}). In response to the measured coolant temperature being greater than both the threshold temperature and greater than an ambient temperature (e.g., an ambient air temperature), control logic 300 may command the bypass valve 214 to move to a radiator mode position whereby the bypass valve 214 controls the coolant to flow through the radiator 210. In response to the measured coolant temperature being less than either of the threshold temperature or the ambient temperature, control logic 300 may command the bypass valve 214 to move to a bypass mode position whereby the bypass valve 214 controls the coolant to bypass the radiator 210. In this regard, the method may comprise sending a valve position command (V_{pos,3}) to the bypass valve 214 to switch between radiator mode and bypass mode, based upon the measured coolant temperature (T_{p,out}). The bypass valve 214 is illustrated downstream from radiator 210 in FIG. 2; though in various embodiments the bypass valve 214 is located upstream from radiator 210, for example at junction 215.

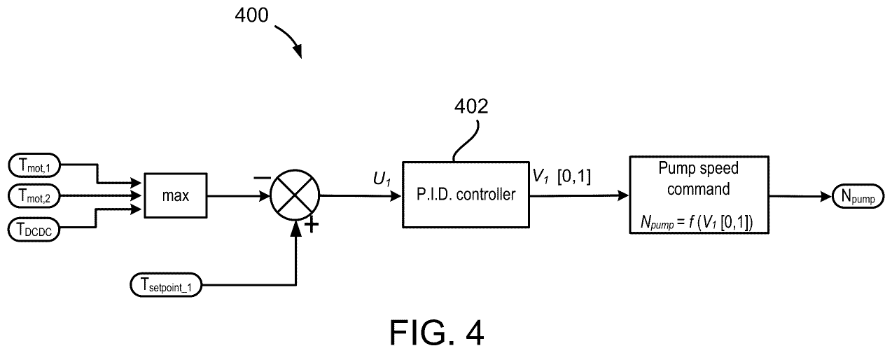

With reference now to FIG. 4, a block diagram of control logic 400 for a thermal management system (e.g., powertrain thermal management system 200) is illustrated, in accordance with various embodiments. Control logic 400 may implement a method for managing thermal loads in an electric vehicle (e.g., a BEV and/or a FCEV). More specifically, and with combined reference to FIG. 2 and FIG. 4, control logic 400 may be implemented for regulating the powertrain loop pump speed (Nₚᵤₘₚ) of pump 218 (also referred to herein as a coolant pump) for the powertrain thermal management system 200. In this regard, the powertrain loop pump speed (Nₚᵤₘₚ) may be regulated using a PID (proportional-integral-derivative) controller 402 based on feedback of the coolant temperature (e.g., T_{mot,1} and T_{mot,2}) at the outlet of each electric motor 232a and 232b, respectively, and the coolant temperature (e.g., T_{DCDC}) at the outlet of the DC-DC converter 226c. The difference between a first coolant temperature setpoint/reference (e.g., T_{setpoint_1} could be 65° C. or another suitable temperature as desired) and the maximum of measured temperatures (e.g., T_{mot,1} and T_{mot,2}, and T_{DCDC}) at the outlets of each electric motor 232a and 232b and DC-DC converter 226c, respectively, is used as the error value (U₁) for the PID controller 402. This error value is minimized by the PID controller 402 by adjusting and optimizing the PID output variable (V₁) using proportional, integral, and/or derivative control actions. The output variable (V₁) may be a value between 0 and 1. The output variable (V₁) may then be used to compute the powertrain loop pump speed (Nₚᵤₘₚ), for example via a LUT (look-up table) or a polynomial expression. In this regard, the method may comprise sending a powertrain loop pump speed (Nₚᵤₘₚ) to the pump 218 to regulate the speed of pump 218, and thereby regulate the flow of coolant through inverters 230, electric motors 232, air compressor 220, brake resistor controller 222, and DC-DC converters 226, based upon the maximum of the measured coolant temperatures (T_{mot,1}, T_{mot,2}, and T_{DCDC}). The pump 218 may circulate the flow of coolant through the powertrain thermal management system 200.

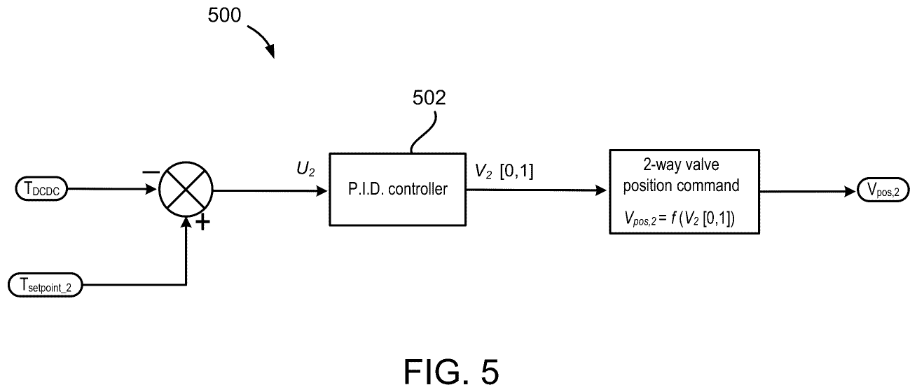

With reference now to FIG. 5, a block diagram of control logic 500 for a thermal management system (e.g., powertrain thermal management system 200) is illustrated, in accordance with various embodiments. Control logic 500 may implement a method for managing thermal loads in an electric vehicle (e.g., a BEV and/or a FCEV). More specifically, and with combined reference to FIG. 2 and FIG. 5, control logic 500 may be implemented for regulating a valve position of flow split valve 224 of powertrain thermal management system 200. The valve position of flow split valve 224 may be regulated using a PID controller 502 based on feedback of the coolant temperature (e.g., T_{DCDC}) at the outlet of DC-DC converter 226c. The difference between a second coolant temperature setpoint/reference (e.g., T_{setpoint_2} may be 65° C. or another suitable temperature as desired) and the measured temperature at the DC-DC converter outlet (e.g., the outlet of DC-DC converter 226c) is used as the error value (U₂) for the PID controller 502. This error value is minimized by the PID controller 502 by adjusting and optimizing the PID output variable (V₂) using proportional, integral, and/or derivative control actions. The output variable (V₂) may be a value between 0 and 1. The output variable is then used to compute the valve position (V_{pos,2}) (e.g., of flow split valve 224), for example via a LUT or a polynomial expression. In this regard, the method may comprise sending a valve position command (V_{pos,2}) to the split valve 224 to regulate the flow of coolant through split valve 224 and through the DC-DC converters 226.

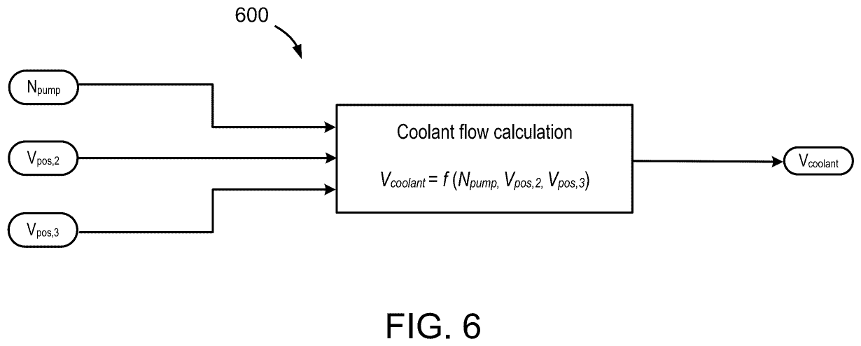

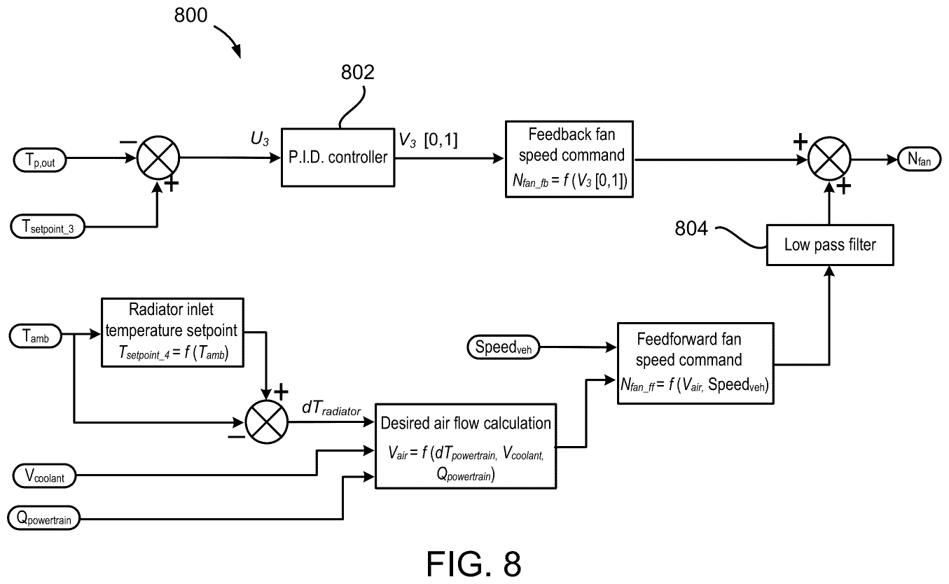

With reference now to FIG. 6, a block diagram of control logic 600 for a thermal management system (e.g., powertrain thermal management system 200) is illustrated, in accordance with various embodiments. Control logic 600 may implement a method for managing thermal loads in an electric vehicle (e.g., a BEV and/or a FCEV). More specifically, and with combined reference to FIG. 2 and FIG. 6, control logic 600 may be implemented for actively calculating a powertrain loop coolant flow rate (V_{coolant}). The pump speed command (Nₚᵤₘₚ), split valve position command (V_{pos,2}), and bypass valve position command (V_{pos,3})—discussed above with respect to FIG. 3, FIG. 4, and FIG. 5—can be used to compute the powertrain loop coolant flow rate (V_{coolant}), for example via a 3D LUT or an empirical correlation. In various embodiments, the powertrain loop coolant flow rate (V_{coolant}) may be stored in memory and used for calculating a radiator fan speed as described with respect to FIG. 8.

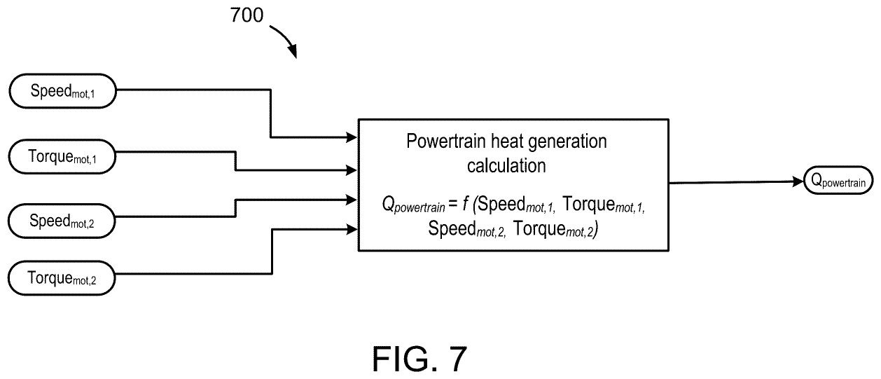

With reference now to FIG. 7, a block diagram of control logic 700 for a thermal management system (e.g., powertrain thermal management system 200) is illustrated, in accordance with various embodiments. Control logic 700 may implement a method for managing thermal loads in an electric vehicle (e.g., a BEV and/or a FCEV). More specifically, and with combined reference to FIG. 2 and FIG. 7, control logic 700 may be implemented for actively calculating powertrain heat generation (Q_{powertrain}). In various embodiments, the powertrain heat generation (Q_{powertrain}) is calculated actively by a VCM (vehicle control module). The speed (Speed_{mot,1} and Speed_{mot,2}) and torque (Torque_{mot,1} and Torque_{mot,2}) are continuously measured for each electric motor 232a and 232b. Using the electric motor measurements, the powertrain heat generation (Q_{powertrain}) can be computed, for example via a LUT or an empirical correlation. In various embodiments, the powertrain heat generation (Q_{powertrain}) may be stored in memory and used for calculating a radiator fan speed as described with respect to FIG. 8.

With reference now to FIG. 8, a block diagram of control logic 800 for a thermal management system (e.g., powertrain thermal management system 200) is illustrated, in accordance with various embodiments. Control logic 800 may implement a method for managing thermal loads in an electric vehicle (e.g., a BEV and/or a FCEV). More specifically, and with combined reference to FIG. 2 and FIG. 8, control logic 800 may be implemented for regulating powertrain loop radiator fan speed (N_{fan}). The powertrain loop radiator fan speed (N_{fan}) may be regulated using a combination of feedback control (PID) and feedforward control. Feedforward control tends to account for measured disturbances (for example, electric motor speed and torque during vehicle acceleration) using a process model before the measured disturbances affect the process. Feedback control tends to compensate for unmeasured disturbances by providing corrective action after they affect the process. The combined feedback and feedforward control tends to ensure smooth performance of the powertrain thermal management system 200.

The feedback portion of the fan speed command may be regulated using a PID controller 802 based on feedback of the coolant temperature (T_{p,out}) at the outlet of the pump 218. The difference between a third coolant temperature setpoint/reference (e.g., T_{setpoint_3} may be 60° C. or another suitable temperature as desired) and the measured temperature (T_{p,out}) at the pump 218 outlet is used as the error value (U₃) for the PID controller. This error value (U₃) may be minimized by the PID controller by adjusting and optimizing the PID output variable (V₃) using proportional, integral, and/or derivative control actions. The output variable (V₃) may be a value between 0 and 1. The output variable (V₃) is then used to compute the feedback part of the radiator fan speed command (N_{fan_fb}), for example via a LUT or a polynomial expression.

For the feedforward controller, a process model (e.g., a heat transfer model) may be used to correlate the effect of measured disturbances (e.g., electric motor speed and torque) on the controlled variable (fan speed). The measured electric motor speed and torque may be used to calculate the powertrain heat generation as previously described with respect to FIG. 7. A radiator inlet coolant temperature setpoint (T_{setpoint_4}) may be computed using the measured ambient temperature (T_{amb}), for example via a LUT or a polynomial expression. A radiator temperature differential (dT_{radiator}) may be defined as the difference between the radiator inlet coolant temperature setpoint (T_{setpoint_4}) and the measured ambient temperature (T_{amb}). Using the powertrain heat generation (Q_{powertrain}), the powertrain loop coolant flow rate (V_{coolant}), and the radiator temperature differential (dT_{radiator}), the desired radiator air flow (Vₐᵢᵣ) may be computed, for example via a 3D LUT or an empirical radiator heat transfer model. The measured vehicle speed (Speedᵥₑₕ) can then be utilized along with the desired radiator air flow (Vₐᵢᵣ) to calculate the feedforward part of the radiator fan speed command (N_{fan_ff}). A first order (or second order) low pass filter 804 (also referred to as a lag filter) may be applied to the feedforward part (N_{fan_ff}) before it is added to the feedback part (N_{fan_fb}) to obtain the final radiator fan speed (N_{fan}). In this regard, the method may comprise sending the final radiator fan speed (N_{fan}) to the radiator fan 212 to regulate the fan speed of radiator fan 212, thereby regulating the coolant temperature.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” or “at least one of A, B, and C” is used in the claims or disclosure, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching may be used throughout the figures to denote different parts but not necessarily to denote the same or different materials.

Methods, systems, and articles are provided herein. In the detailed description herein, references to “one embodiment”, “an embodiment”, “various embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is intended to invoke 35 U.S.C. 112(f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A vehicle powertrain thermal management system, comprising:
a first coolant flow path comprising a flow split valve upstream of a first DC-DC converter;
a second coolant flow path comprising a first electric motor;
a third coolant flow path comprising a second electric motor;
a bypass valve positioned downstream of the first DC-DC converter, the first electric motor, and the second electric motor; and
a radiator positioned one of directly upstream or directly downstream of the bypass valve,
wherein the first coolant flow path, the second coolant flow path, and the third coolant flow path are fluidly connected in parallel.

2. The vehicle powertrain thermal management system of claim 1, further comprising a pump upstream of the first coolant flow path, the second coolant flow path, and the third coolant flow path.

3. The vehicle powertrain thermal management system of claim 1, wherein the flow split valve is a two-way valve capable of regulating a coolant flow to the first DC-DC converter.

4. The vehicle powertrain thermal management system of claim 1, further comprising a second DC-DC converter downstream of the first DC-DC converter and a third DC-DC converter downstream of the second DC-DC converter.

5. The vehicle powertrain thermal management system of claim 1, wherein the bypass valve is a three-way valve configured to direct a coolant to the radiator or bypass the radiator.

6. The vehicle powertrain thermal management system of claim 1, wherein the first coolant flow path further comprises an air compressor and a brake resistor controller.

7. The vehicle powertrain thermal management system of claim 6, wherein the brake resistor controller is directly upstream of the flow split valve.

8. The vehicle powertrain thermal management system of claim 1, wherein the second coolant flow path further comprises a first inverter directly upstream of the first electric motor.

9. The vehicle powertrain thermal management system of claim 8, wherein the third coolant flow path further comprises a second inverter directly upstream of the second electric motor.

10. The vehicle powertrain thermal management system of claim 5, wherein the bypass valve is directly upstream of the radiator.

11. A vehicle powertrain thermal management system, comprising:
a first coolant flow path comprising an air compressor and a brake resistor controller;
a second coolant flow path comprising a first inverter;
a third coolant flow path comprising a second inverter;
a bypass valve positioned downstream of the air compressor, the brake resistor controller, the first inverter, and the second inverter; and
a radiator positioned one of directly upstream or directly downstream of the bypass valve,
wherein the first coolant flow path, the second coolant flow path, and the third coolant flow path are fluidly connected in parallel.

12. The vehicle powertrain thermal management system of claim 11, further comprising a pump directly upstream of the first coolant flow path, the second coolant flow path, and the third coolant flow path.

13. The vehicle powertrain thermal management system of claim 11, wherein the bypass valve is a three-way valve configured to direct a coolant to the radiator or bypass the radiator.

14. The vehicle powertrain thermal management system of claim 13, wherein the bypass valve is directly upstream of the radiator.

15. The vehicle powertrain thermal management system of claim 11, further comprising a first DC-DC converter.

16. The vehicle powertrain thermal management system of claim 15, wherein the first DC-DC converter is included in the first coolant flow path.

17. The vehicle powertrain thermal management system of claim 16, wherein the first DC-DC converter is downstream of the brake resistor controller.

18. The vehicle powertrain thermal management system of claim 11, further comprising a flow split valve.

19. The vehicle powertrain thermal management system of claim 18, wherein the flow split valve is a two-way valve capable of regulating a coolant flow.

20. The vehicle powertrain thermal management system of claim 11, further comprising a first electric motor downstream of the first inverter and a second electric motor downstream of the second inverter.
